(19) United States
(12) Patent Application Publication
(10) Pub. No.: US 2015/0231643 A1
(43) Pub. Date: Aug. 20, 2015

(54) TUMBLER GRINDER SCREEN

(71) Applicant: Vermeer Manufacturing Company, Pella, IA (US)

(72) Inventor: Duane R. DeBoef, Sherrard, IL (US)

(21) Appl. No.: 14/312,295

(22) Filed: Jun. 23, 2014

Related U.S. Application Data
(60) Provisional application No. 61/950,997, filed on Mar. 11, 2014.
(60) Provisional application No. 61/941,840, filed on Feb. 19, 2014.

(51) Int. Cl. B02C 19/20; B02C 13/284; B02C 23/16

(52) U.S. Cl. CPC B02C 19/20; B02C 23/16; B02C 13/284; B02C 2023/165

(57) ABSTRACT

The present disclosure relates generally to a material reducing screen having an inner side and an outer side. The material reducing screen includes a plurality of slot openings and a material tumbler bar extending across the plurality of slot openings. The material reducing screen may be included, for example, in one of a horizontal grinder and a tub grinder.

### CROSS-REFERENCE TO RELATED APPLICATIONS

The present patent application claims the benefit of U.S. Provisional Patent Application Ser. No. 61/950,997, filed Mar. 11, 2014 and claims the benefit of U.S. Provisional Patent Application Ser. No. 61/941,840, filed Feb. 19, 2014, which applications are hereby incorporated by reference in their entireties.

### TECHNICAL FIELD

The present disclosure relates generally to material reducing machines. In to particular, the present disclosure relates to material reducing machines such as grinders.

### BACKGROUND

Material reducing machines are used to reduce waste materials such as trees, brush, stumps, pallets, root balls, railroad ties, peat moss, paper, wet organic materials and the like. One common type of material reducing machine includes grinders. Grinders are typically configured to reduce material through blunt force impactions. Thus, the reduced material product generated by grinders generally has a ground, flattened texture with relatively high fines content. This type of reduced material is typically used as mulch. Two common types of grinders include tub grinders and horizontal grinders. Example horizontal grinders are disclosed in U.S. Pat. Nos. 7,461,832; 7,441,719; 5,975,443; 5,947,395; 6,299,082; and 7,077,345. Example tub grinders are disclosed in U.S. Pat. Nos. 5,803,380; 6,422,495; and 6,840,471.

A horizontal grinder typically includes a power in-feed mechanism that forces larger material (e.g., wood-based material such as tree trunks, tree branches, logs, etc.) into contact with a rotating grinding drum. The larger material is contacted by teeth carried by the grinding drum and portions of the material are forced past a fixed shear edge defined by an anvil of the horizontal grinder. Upon passing the fixed shear edge of the anvil, the material enters a grinding chamber defined at least in part by a sizing screen that extends around a portion of the grinding drum. Within the grinding chamber, the material is further reduced by the teeth carried by the grinding drum. Once the material within the grinding chamber is reduced to a certain particle size, the material is discharged through sizing openings of the sizing screen. Upon passing through the sizing openings of the sizing screen, the reduced material is typically deposited on a discharge conveyor that carries the reduced material to a collection location.

### SUMMARY

Aspects of the present disclosure relate to a material reducing machine having features that enhance the size uniformity of the reduced product generated by the material reducing machine. In one embodiment, the material reducing machine includes a material reducing screen having an inner side and an outer side. The material reducing screen includes a plurality of slot openings and a material tumbler bar extending across the plurality of slot openings.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is an isometric of an embodiment of an overall comminution machine, in accordance with the principles of the present disclosure;

FIG. 2 is a schematic representation of the basic components of the comminution machine of FIG. 1 as taken from section line 2-2, as shown in FIG. 1;

FIG. 3 is a perspective view showing a screen assembly partially surrounding a rotational reducing unit, in accordance with the principles of the present disclosure;

FIG. 4 is a perspective view of a screen support structure frame, in accordance with the principles of the present disclosure;

FIG. 5 is a perspective view of a screen plate mounted on the screen support structure frame of FIG. 4, in accordance with the principles of the present disclosure;

FIG. 6 is a perspective view showing abrasion resistance bars mounted on the screen plate of FIG. 5;

FIG. 7 is a perspective view of one of the abrasion resistance bar shown in FIG. 6;

FIG. 8 is a front perspective view of FIG. 6;

FIG. 9 is a cross-sectional view taken along section line 9-9 of FIG. 8;

FIG. 9A is an enlarged view of a portion of FIG. 9;

FIG. 10 is a top isometric perspective view of an example tub grinder including a grinder within a tub, in accordance with the principles of the present disclosure; and

FIG. 11 is a cross-sectional view of the tub and grinder shown in FIG. 10.

### DETAILED DESCRIPTION

With reference now to the various figures in which identical components are numbered identically throughout, a description of various exemplary aspects of the present disclosure will now be provided. The disclosed embodiments are shown in the drawings and described with the understanding that the present disclosure is to be considered an exemplification of certain inventive aspects and is not intended to limit the inventive aspects to the embodiments disclosed.

Various machines have been developed for comminuting materials. Examples, with common names, include: shredders, having a relatively slow speed comminuting apparatus typically used for ripping and breaking hard, tough materials apart into relative coarse particles; chippers having a relatively high speed comminuting apparatus, either a rotating disc or a rotating drum, with sharp material reducing components typically used for cutting wood materials into small chips; and grinders having a relatively high speed comminuting apparatus, a rotating drum typically with robust and blunt material reducing components, that is located adjacent a sizing screen that is used to tear and shatter materials into a variety of particle sizes.

Each of these machines has an infeed section, a comminution section, and a discharge section. Various combinations of these various components have been developed to process certain types of materials. The current disclosure is applicable to grinders (e.g., tub grinders and horizontal grinders), shredders and chippers, but the comminution technology disclosed herein is not limited to those configurations.

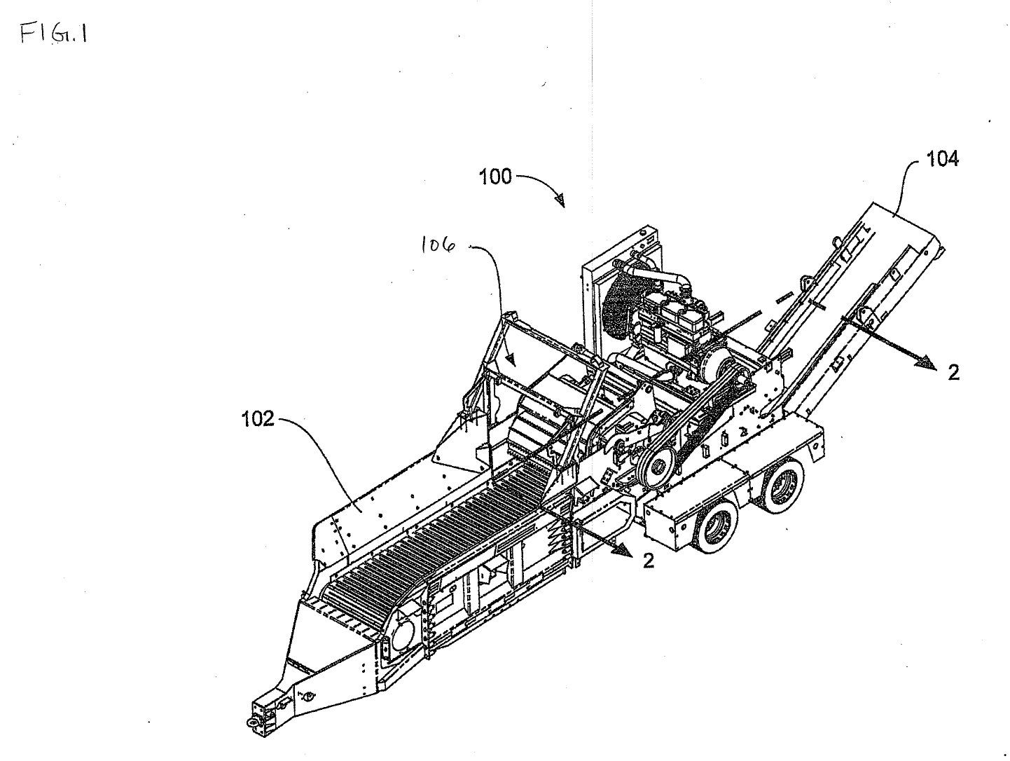

FIG. 1 is one embodiment of a complete machine, a horizontal grinder 100 with an infeed system 102 (e.g., a conveyor), a discharge system 104 (e.g., a conveyor) and a comminution apparatus 106.

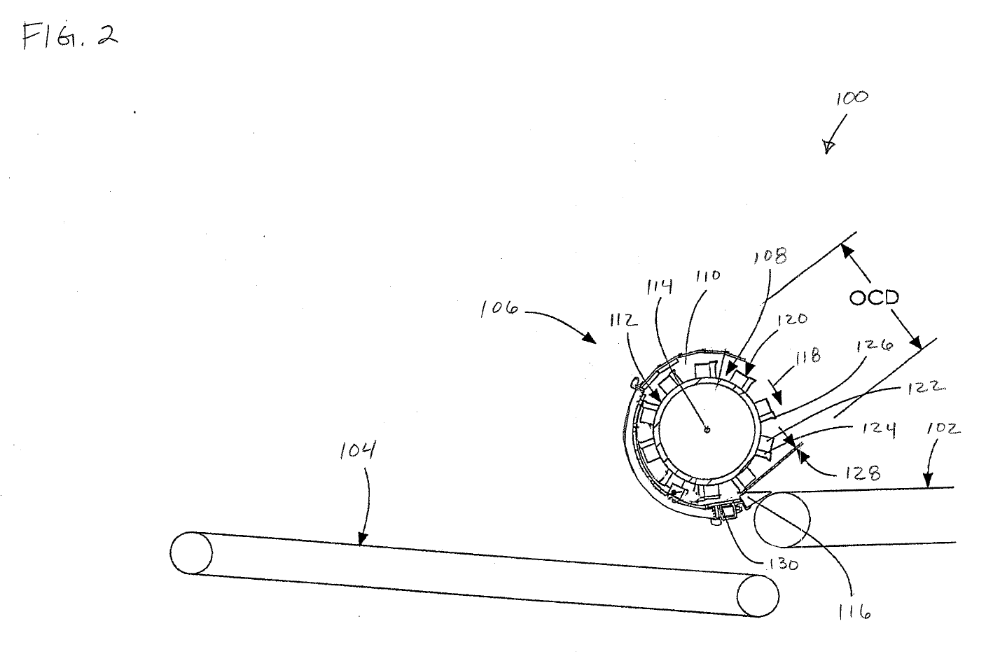

As shown at FIG. 2, the comminution apparatus 106 includes a rotational reducing unit 108 mounted within a comminution chamber 110. The present disclosure describes aspects of a comminution apparatus that can be used in combination with other types of infeed devices and/or discharge devices. For example, comminution apparatuses in accordance with the present disclosure can be used with tub grinder type infeed systems having top-load tubs with rotating sidewalls that help feed material toward comminution apparatuses mounted at floors of the tubs.

The rotational reducing unit 108 illustrated in FIG. 2 includes a material reducing component carrier depicted as a drum 112 that is rotationally driven about a central axis of rotation 114 by a drive mechanism. One example of this style of drum is described in more detail in U.S. Pat. No. 7,204,442, herein incorporated by reference. Other styles of reducing component carriers are disclosed at U.S. Pat. Nos. 5,507,441; 7,213,779; and 6,840,471 that are hereby incorporated by reference. The drum 112 is located adjacent the infeed system 102. An anvil 116 is located at the end of the infeed system 102. One example of a suitable anvil is described in more detail in U.S. Pat. No. 7,461,802, herein incorporated by reference. The anvil 116 is located such that rotation of the drum 112 in a reducing direction 118 about the central axis of rotation 114 will move the material from the infeed system 102 into contact with the anvil 116. Some machine configurations use an opposite direction of rotation of the drum, such that the material is lifted up, in a machine known as an up-cut machine, rather than down as in this depicted embodiment. Aspects of the present disclosure would work in an up-cut machine, but for the sake of clarity, this disclosure will focus only on the illustrated embodiment.

The drum 112 can carry any number of material reducing components (e.g., edges, grinding members, cutters, plates, blocks, blades, bits, teeth, pics, hammers, shredders or combinations thereof) 120 supported in any preferred method. In certain embodiments, the material reducing components 120 can have a blunt configuration having a blunt impact region. The blunt impact region can be rounded so as to be less prone to rapid wear and so as to provide more of a grinding action as compared to a chipping action. However, in other embodiments, material reducing components 120 with sharp edges/blades or points suitable for chipping or cutting can be used. In one embodiment, when the drum 112 is rotated the material reducing components 120 are swept along an outer cutting diameter OCD.

Referring to FIG. 2, the drum 112 is shown carrying material reducing components 120 in the form of a plurality of reducing hammers 122 that project radially outwardly from the drum 112 and/or radially outwardly from the central axis of rotation 114.

Leading faces of the reducing hammers 122 are covered and protected by reducing blocks 124 that are fastened to the reducing hammers 122. The reducing blocks 124 have outermost reducing edges 126 oriented to extend primarily along the central axis of rotation 114 of the rotational reducing unit 108. In certain embodiments, the outermost reducing edges 126 can be rounded or otherwise blunt. When the rotational reducing unit 108 is rotated about the central axis of rotation 114, the outermost edges 126 move along the outer cutting diameter (OCD) of the reducing unit 108. Examples of material reducing components and reducing hammers are disclosed at U.S. Publication No. 2013/0161427 A1, herein incorporated by reference in its entirety.

The anvil 116 can be positioned within a specific distance of the outer cutting diameter of the material reducing components 120. Depending upon the system and the type of material being processed, the size of a gap 128 can be varied, and may be adjustable in certain embodiments. The anvil 116 defines the end of the infeed. Material being comminuted, generally referred to herein generically as material, is propelled by the material reducing components 120 rotated by drum 112, to pass-by the anvil 116. The material travels either in front of the material reducing components 120 or between the material reducing components and the anvil 116, through the gap 128. As the material continues to travel with the drum, centrifugal force will cause the material to move, away from the central axis of rotation 114 of the drum 112, and into contact with a transition plate 130. In the depicted embodiment, the plate 130 is a stiff, solid plate that forces the material to remain engaged with the material reducing components 120.

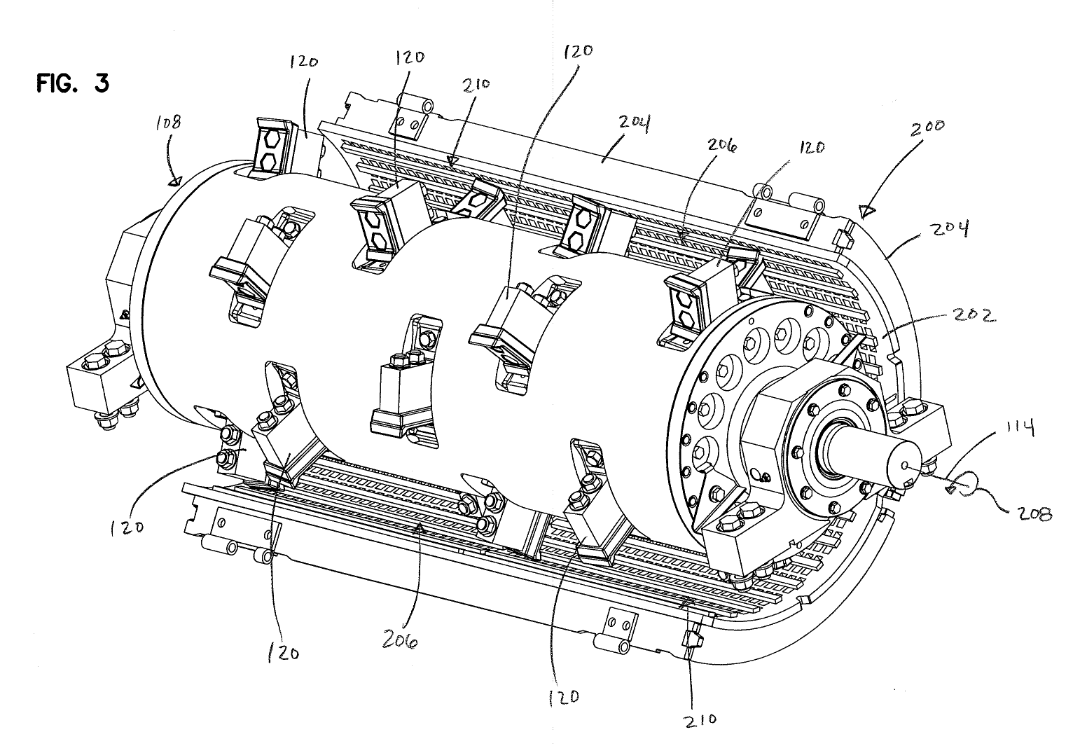

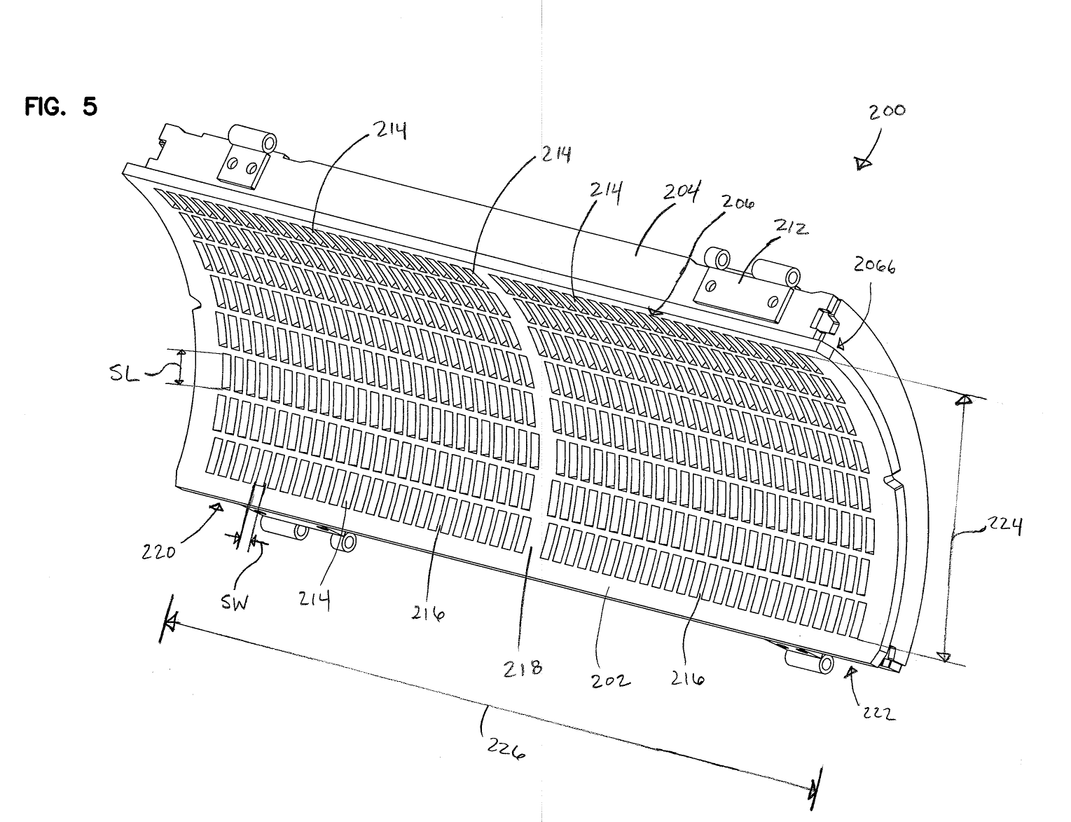

FIG. 3 depicts a screen assembly 200 including a screen plate 202 (e.g., a material reducing screen) and a screen support structure 204 (i.e. a reinforcing framework). The screen assembly 200 can be removable from the grinder 100 (see FIG. 1) as a unit. The screen assembly 200 is positioned to circumferentially surround a portion of the rotational reducing unit 108. During reducing operations, the rotational reducing unit 108 is rotated about the central axis of rotation 114, and the material reducing components 120 are moved along an inside surface 206 (e.g., inner side) of the screen plate 202. In one example, the inside surface 206 of the screen plate 202 faces toward the drum 112. As shown in FIG. 5, the screen plate 202 can include an outer surface 206b (e.g., outer side) that faces away from the drum 112 (see FIG. 2). Movement of the material reducing components 120 along the inside surface 206 of the screen plate 202 is caused by rotation of the rotational reducing unit 108 in direction 208 about central axis of rotation 114, thereby causing the material reducing components 120 to sweep along the outer cutting diameter OCD (see FIG. 2). As the material reducing components 120 move along the outer cutting diameter OCD, the material reducing components 120 sweep across a screening region 210 in an upstream-to-downstream direction. The screen plate 202 is illustrated and described in more detail in FIG. 5.

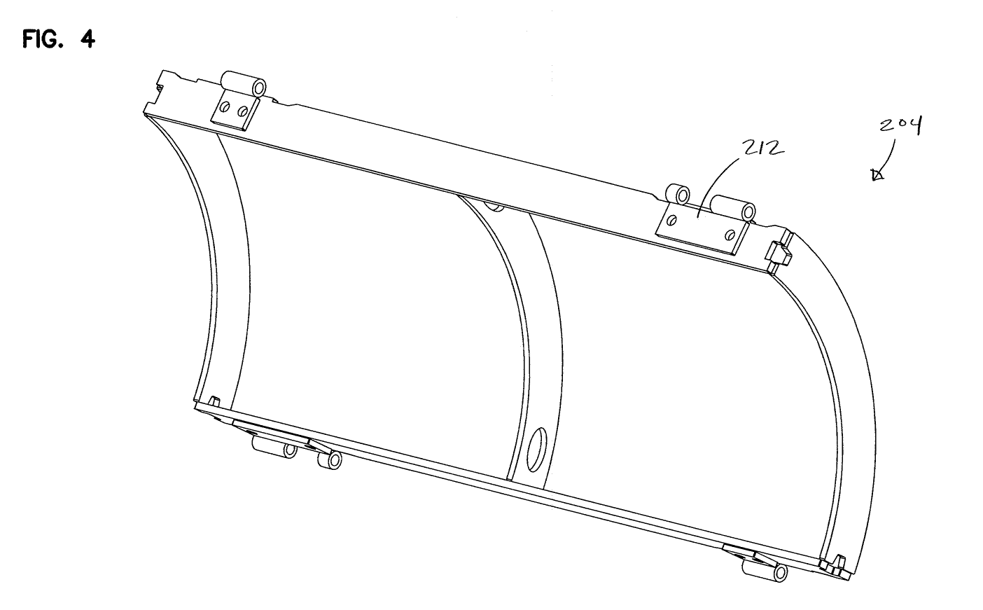

Referring to FIG. 4, a perspective view of the screen support structure 204 is shown. In certain examples, the screen support structure 204 assists in making the screen plate 202 (see FIG. 3) more rigid and also provides means (e.g., a fastening plate 212) for allowing the screen plate 202 to be easily lowered into and lifted out of a comminution apparatus with a structure such as a lift or crane.

Referring to FIG. 5, a perspective view of the screen plate 202 is illustrated. The screen plate 202 includes a plurality of slot openings 214 (e.g., apertures) of relatively narrow construction, with a minimal land area 216 between each slot opening 214. In the depicted example, the screen plate 202 includes a sizeable land area 218 in the center of the screen plate 202 that generally divides the screen plate 202 into a first half 220 and a second half 222. The sizeable land area 218 may also extend along a border of the sheet plate 202. In certain examples, the screen plate 202 can be arcuate, such that the inside surface 206 is concave and adjacent the outer tip reducing/cutting diameter defined by the material reducing components 120 (see FIG. 2), when mounted to the drum 112 (see FIG. 2).

The screen plate 202 can be manufactured, in its final form, as an arcuate plate. The slot openings 214 can be cut into the plate in a number of ways, including cutting the slots after the plate is rolled into its final form, or cutting the slots while the plate is flat, and then forming it into the final arcuate shape. Further alternatively, the screen plate 202 could be molded so as to have slot openings 214 therein, eliminating the need for a further cutting or other forming step. The slot openings 214 can have slot lengths SL and slot widths SW. The slot openings 214 are elongated along the slot lengths SL. In one example, the slot lengths SL can be greater than the slot widths SW. In other examples, the slot lengths SL can be smaller than the slot widths SW. In still other examples, the slot lengths SL and the slot widths SW may be substantially the same or equal.

In the depicted example, the slot lengths SL of the slot openings 214 are shown extending primarily along the upstream-to-downstream screen dimension 224. The slot widths SW are shown extending primarily along the cross-screen dimension 226. The slot openings 214 are spaced-apart from one another (e.g., by land areas 216) along the cross-screen dimension 226. The slot openings 214 are continuously open (i.e., open without interruption) along their slot lengths SL.

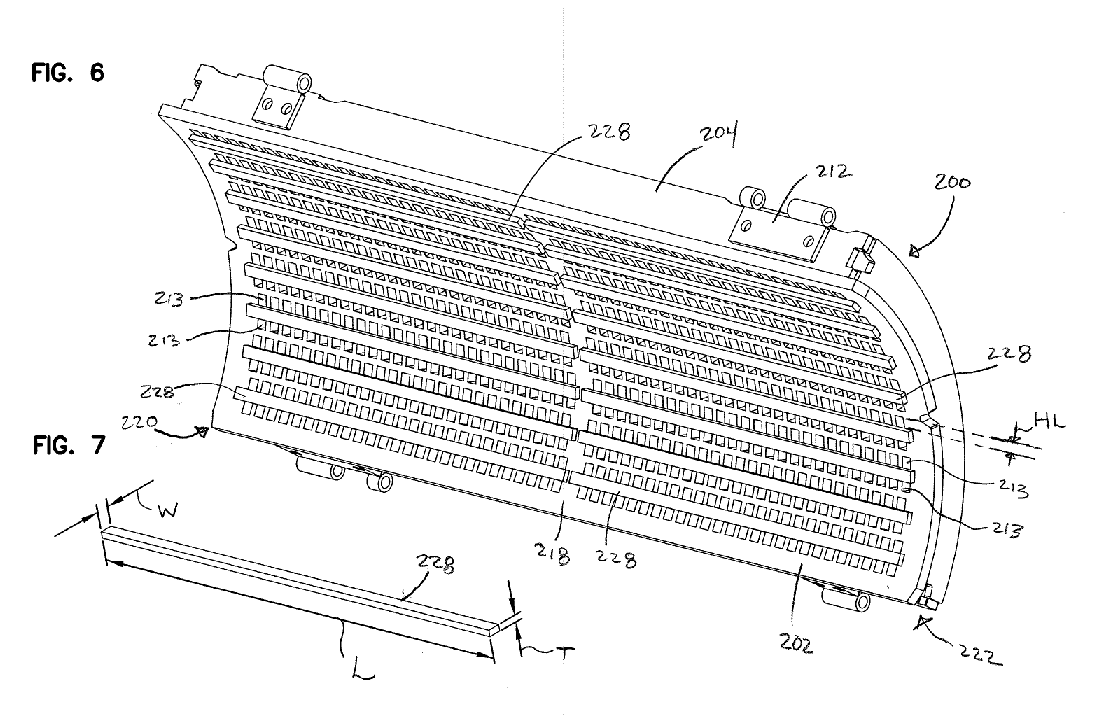

Referring to FIG. 6, a perspective view of the screen assembly 200 is shown with the screen plate 202 mounted to the screen support structure 204. In one example, the screen plate 202 includes a plurality of horizontal bars 228 (e.g., material tumbler bars) secured over the slot openings 214. The plurality of horizontal bars 228 can be made of a wear resistant material (e.g., any wear resistant, and weldable/brazable material) and are configured to be welded, brazed, or otherwise metallurgically attached to the screen plate 202. It is to be understood that the horizontal bars 228 can be attached to the screen plate 202 by other methods (e.g., adhesive). In certain examples, the wear resistant material of the horizontal bars 228 is harder than the material comprising the screen plate 202. The plurality of horizontal bars 228 can extend along the screen plate 202 primarily along the cross-screen dimension 226. In one example, the plurality of horizontal bars 228 can be divided to mount to the first half 220 and the second half 222 of the screen plate 202. In other examples, the plurality of horizontal bars 228 can be mounted across the screen plate 202 such that the plurality of horizontal bars 228 is not divided. In certain examples, the sizeable land area 218 separates the plurality of horizontal bars 228 between the first and second halves 220, 222 of the screen plate 202. The horizontal bar 228 is illustrated and described in more detail in FIG. 7.

In some examples, the plurality of horizontal bars 228 can be welded from the backside of the screen plate 202 because of the positioning of the plurality of horizontal bars 228 across the slot openings 214 rather than being positioned over webbing between the slot openings 214. Welds 215 (see FIG. 9A) can be provided at the junctions between the horizontal bars 228 and the land areas 216, with access for welding being provided from the outer side of the screen through the slot openings 214. The horizontal bars 228 can be metallurgically attached to at least one junction between the horizontal bars 228 and the land areas 216.

The plurality of horizontal bars 228 can be positioned to overlay the center of the slot openings 214 on an inside radius of the surface of the screen plate 202. For example, the plurality of horizontal bars 228 can be arranged and configured to physically make the slot openings 214 smaller at the inside surface 206 of the screen plate 202 by forming holes 213 (e.g., openings) at the inside surface 206 of the screen plate 202. In one example, the holes 213 are defined by the plurality of horizontal bars 228. The holes 213 (see FIG. 6) can have a hole length HL (see FIG. 6) that is smaller than the slot length SL of the slot openings 214. In one example, the plurality of horizontal bars 228 can be positioned to split the size of the slot openings 214 in half at the inside surface 206 of the screen plate 202 in order to form the holes 213 at the inside surface 206. The slot openings 214 at the outside surface 206b can be unbarred so that grounded material can be released and flow freely without resistance. For example, the grounded material would not bind up or plug the slot openings 214. Once the grounded material breaks or pushes through between the plurality of horizontal bars 228 and the screen plate 202, the grounded material is capable of being passed from the inside surface 206 of the screen plate 202 to the outer surface 206b of the screen plate 202 through the slot openings 214. The slot openings 214 behind the plurality of horizontal bars 228 at the outer surface 206b of the screen plate 202 are larger than the holes 213 defined between the slot openings 214 and the plurality of horizontal bars 228 at the inside surface 206 of the screen plate 202.

Higher production can be achieved due to the natural relief of the grounded product (e.g., shingle, woody material) material being able to flow through the slot openings 214 that have no web underneath. More open area can be provided by the slot openings 214 underneath the plurality of horizontal bars 228 such that the flow of material can pass freely through the slot openings 214. The horizontal bars 228 can extend across the slot openings 214 such that each slot opening 214 has an open region upstream and downstream of its corresponding horizontal bar 228. In one example, the horizontal bars 228 bisect the slot lengths SL.

In one example, the plurality of horizontal bars 228 act as speed bumps such that the shingles or other product (e.g., woody material) being subject to grinding catches the plurality of horizontal bars 228 and are forced upwardly to beat against the plurality of horizontal bars 228. The material can be stopped in more directions when they are in contact with the plurality of horizontal bars 228 and the screen plate 202. The plurality of horizontal bars 228 can block or slow down the flow or rotational direction of grinded materials. The grounded material can stay between the plurality of horizontal bars 228 and wait to pass through the screen plate 202 allowing for more opportunity to pass through the screen plate 202. If the grounded material does not pass through the screen plate 202, it can be forced or tumbled back into the path of the reducing hammers 122. Because of the configuration of the plurality of horizontal bars 228 on the screen plate 202, the product or shingles are less likely to snake around the inside surface 206 of the screen plate 202.

The plurality of horizontal bars 228 protects the screen plate 202 by experiencing much of the wear due to much of the material wear being mainly isolated to the plurality of horizontal bars 228. The plurality of horizontal bars 228 can help protect the screen plate 202 such that the screen plate 202 is worn out slower, resulting in a longer service life of the screen plate 202. The plurality of horizontal bars 228 may be welded (e.g., in the form of a fillet weld) on to the front side of the screen plate 202 adjacent given slots opening 214, via access through the back side of the screen plate 202. In particular, the welds 215 are located within slot openings 214 at a junction between the plurality of horizontal bars 228 and corresponding land areas 216. Fillet welding in this manner allows for easy removal and placement of new bars. The plurality of horizontal bars 228 can be readily replaceable by torching or cutting off the worn plurality of horizontal bars 228 and welding new ones back on. The worn material can be removed without interfering with the structure of the screen plate 202. The plurality of horizontal bars 228 can be replaced 3-4 times before discarding the screen plate 202. The replacement of the plurality of horizontal bars 228 has a greater economic impact because the productivity and service life of the screen plate 202 increases.

Referring to FIG. 7, one of the plurality of horizontal bars 228 is depicted. In one example, the plurality of horizontal bars 228 has generally a rectangular shape that can have a length L, a width W, and a thickness T. In certain examples, the width W is less than the slot length SL. In other examples, the width W is no more than 50% of the slot length SL. The size and configuration of the plurality of horizontal bars 228 help to achieve the particle size desired when grinding material. It is to be understood that the shape of the plurality of horizontal bars 228 can vary in other embodiments. For example, the plurality of horizontal bars 228 can have a zigzag shape, etc. In still other examples, the shape of the plurality of horizontal bars 228 can include a sharpened bar with a sharp edge on the front side, the side that first contacts the material, to a simple blunt made from bar stock. A variety of bar designs and mounting methods are possible. In other examples, the plurality of horizontal bars 228 can have a cross sectional shape of a rectangular, circular, square, or diamond.

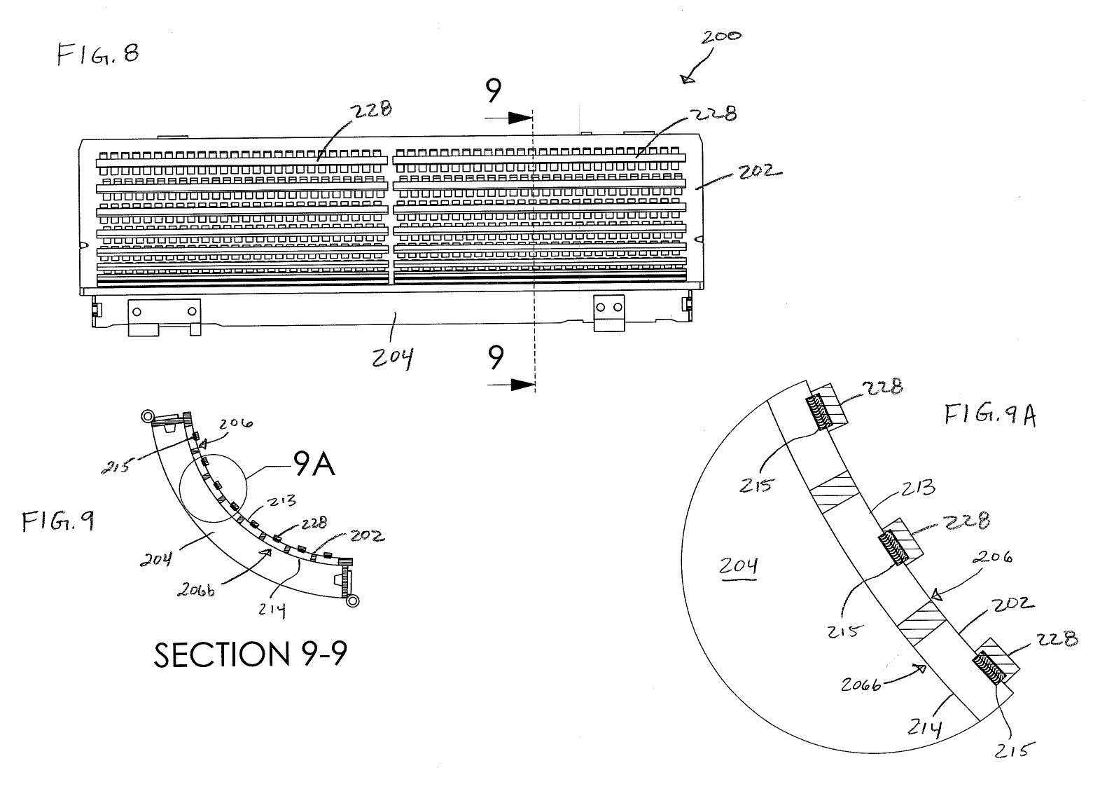

Referring to FIG. 8, a front perspective view of the screen assembly 200 is shown including the screen plate 202, the screen support structure 204, and the plurality of horizontal bars 228 mounted on the screen support structure 204. FIG. 9 is a cross-sectional view taken along section line 9-9 of FIG. 8. As depicted, the symmetry between the plurality of horizontal bars 228 and the slot openings 214 make the screen assembly 200 reversible. The screen assembly 200 can be configured to be removed and reversible, combined with the slot opening configuration and the plurality of horizontal bars 228, and allows for improved utilization due to the ability to utilize both sides of the horizontal bars 228. That one side will experience higher rate of wear than the opposite side. When the wear affects performance, the screen assembly 200 can be removed and reversed, so that the opposite side would be the primary comminution surface. In certain aspects, the screen assembly 200 can be removed and reversed such that it is not necessary for the screen plate 202 to be removed from the screen support structure 204. This can help further simplify the overall rebuild of the screen plate 202.

The next step in rebuilding the screen assembly 200 would be to proceed to replace at least one of the plurality of horizontal bars 228, as discussed above. In short, one of the plurality of horizontal bars 228 would be readily replaced by torching or cutting off the worn horizontal bar and welding a new one back on. The worn material can be removed without interfering with the structure of the screen plate 202.

FIG. 9A illustrates an enlarged view of a portion of FIG. 9. A detailed view of the location of the welds 215 is depicted. The welds 215 are generally protected by the horizontal bars 228. The welds 215 are out of the flow of the grinded material such that the grounded material may flow freely without resistance.

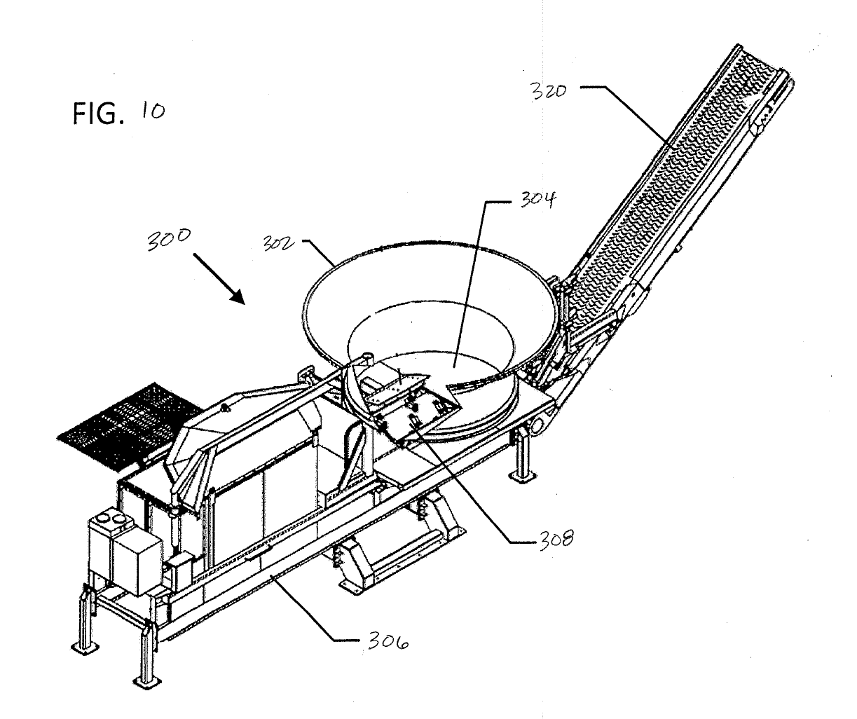

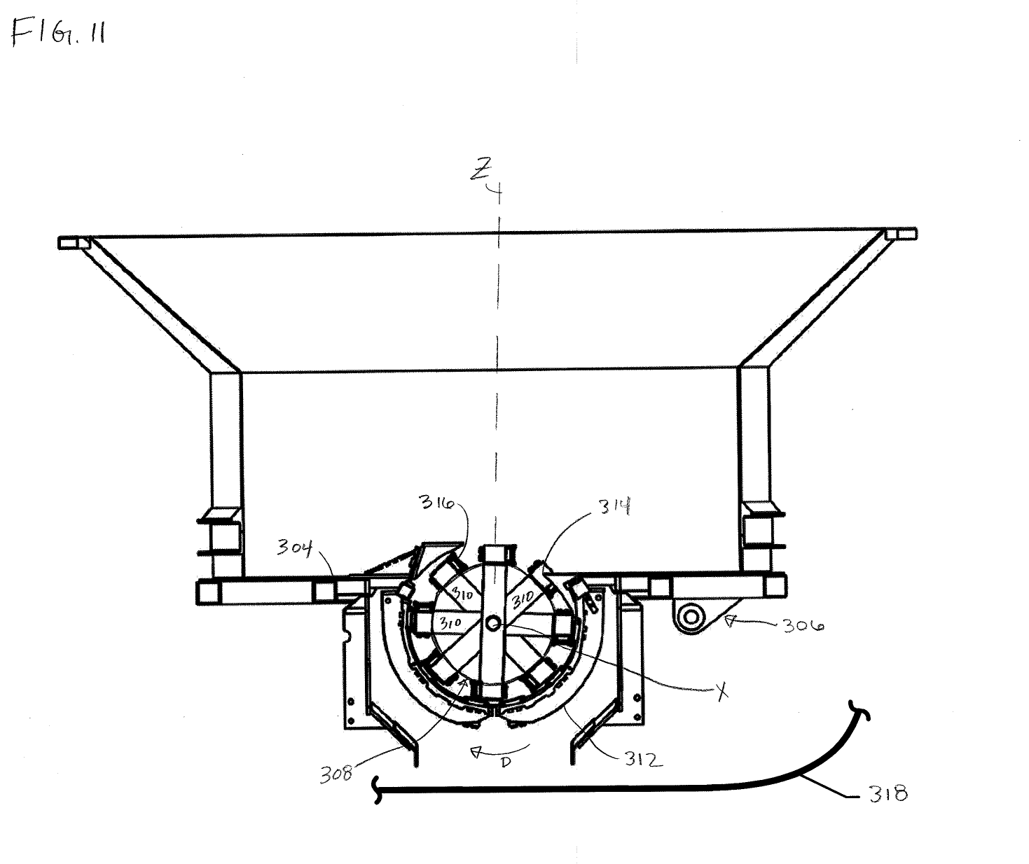

FIGS. 10 and 11 illustrate another example of a tub grinder 300 including a rotary tub 302 mounted above a horizontal floor 304 for rotation about a vertical axis Z. The floor 304 and tub 302 are secured to a frame 306. In some examples, wheels are mounted on the frame 306. In other examples, the frame 306 is configured to be stationary. Tub grinders are intended for use in grinding organic waste material (e.g., brush, wood, grass, leaves, paper, etc.). Debris is deposited in the rotating tub, and the rotary grinding member grinds the debris.

A rotary grinder member 308 (e.g., a comminuting drum) is mounted within the frame 306. The rotary grinder member 308 is coupled via a shaft (not shown) to an engine for rotating the rotary grinder member 308. The rotary grinder member 308 includes a plurality of radially extending hammer members 310 that are configured to rotate about an axis X. In certain examples, the axis X is generally orthogonal to the axis Z. In certain examples, the axis X is generally parallel to the floor 304. In the example shown, the axis X is generally horizontal.

The rotation of the hammer members 310 defines a circular reducing boundary of the rotary grinder member 308. The rotary grinder member 308 also includes a screen 312 mounted around the hammer members 310 at a position offset from the reducing boundary. The screen 312 extends partially around the rotary grinder member 308 and defines one or more exit apertures through which material falls during operation of the rotary grinder member 308. As described above, the screen 312 may include a plurality of horizontal bars (not shown) mounted therein to increase the service life and productivity of the screen 312.

In the example shown in FIG. 11, the rotary grinder member 308 is mounted to the frame 304 so that a portion of the reducing boundary is exposed through an opening 314 defined in the floor 304.

Cutters 316 are mounted to distal ends of the hammer members 310. As the hammer members 310 are rotated about the axis X, each of the cutters 316 spins along a respective annular cutting path. The cutters 316 engage and crush waste material deposited in the rotary tub 302 that enters the cutting paths. The rotary tub 302 may be rotated concurrently with the hammer members 310 to bring the waste material into the cutting paths.

Waste material is deposited into the interior of the rotary tub 302 by a crane, conveyance system, or the like. The combined action of the rotation of the rotary tub 302 and rotation of the rotary grinder member 308 with the plurality of horizontal bars on the screen 312 causes the waste material to be broken down and deposited on a belt 318 carried on the frame 306 beneath the rotary grinder member 308 as shown in FIG. 11. Waste material can be held longer between the plurality of horizontal bars, thereby waiting to be dropped through the screen 312 onto the belt 318 from the rotary grinder member 308. The belt 318 carries the crushed and ground waste material away from the rotary grinder member 308 and deposits the waste onto a conveyor 320 (see FIG. 10) for discharge.

From the forgoing detailed description, it will be evident that modifications and variations can be made without departing from the spirit and scope of the disclosure.

What is claimed is:

1. A material reducing apparatus comprising:
a material reducing screen having an inner side and an outer side, the material reducing screen including:
a plurality of slot openings; and
a material tumbler bar extending across the plurality of slot openings.

2. The material reducing apparatus of claim 1, wherein the material reducing screen includes a cross-screen dimension and an upstream-to-downstream screen dimension, and wherein the material reducing screen curves along the upstream-to-downstream screen dimension such that the inner side is concave and the outer side is convex.

3. The material reducing apparatus of claim 2, wherein the plurality of slot openings each include a slot length and a slot width, wherein the slot length is greater than the slot width.

4. The material reducing apparatus of claim 3, wherein the slot lengths of the slot openings extend primarily along the upstream-to-downstream screen dimension.

5. The material reducing apparatus of claim 3, wherein the slot widths extend primarily along the cross-screen dimension.

6. The material reducing apparatus of claim 2, wherein the material tumbler bar extends across the plurality of slot openings such that each of the plurality of slot openings has an open region upstream and an open region downstream.

7. The material reducing apparatus of claim 3, wherein the material tumbler bar has a width that is less than the slot length.

8. The material reducing apparatus of claim 1, wherein the material reducing screen includes land areas between the plurality of slot openings.

9. The material reducing apparatus of claim 8, wherein the material tumbler bar is metallurgically attached to at least one junction between the material tumbler bar and the land areas.

10. The material reducing apparatus of claim 9, wherein the material tumbler bar is attached by a weld, the weld being located within a slot opening at a junction between the material tumbler bar and a corresponding land proximate the inner side of the material reducing screen.

11. The material reducing apparatus of claim 3, wherein the material tumbler bar has a width of no more than 50% of the slot length.

12. The material reducing apparatus of claim 3, wherein the material tumbler bar bisects the slot length.

13. The material reducing apparatus of claim 1, wherein the material reducing screen is integrated with one of a horizontal grinder, a tub grinder, and a material reducing machine.

14. A material reducing machine comprising:
a grinding drum;
a screen including an inner side that faces toward the grinding drum, the screen defining a plurality of apertures therein; and
a first material tumbler bar located on the inner side of the screen, the first material tumbler bar extending across the plurality of apertures such that the plurality of apertures include an open region upstream and an open region downstream.

15. The material reducing machine of claim 14, wherein the plurality of apertures each include a slot length and a slot width, wherein the slot length is greater than the slot width.

16. The material reducing machine of claim 14, wherein the first material tumbler bar is made from a wear resistant material.

17. The material reducing machine of claim 16, wherein the wear resistant material of the first material tumbler bar is harder than material comprising the screen.

18. The material reducing machine of claim 15, wherein the first material tumbler bar has a width no more than 50% of the slot length.

19. The material reducing machine of claim 14, wherein the plurality of apertures have a geometry selected from the group comprising a rectangular, circular, square, or diamond.

20. The material reducing machine of claim 14, wherein the first tumbler bar has a cross sectional geometry selected from the group comprising a rectangular, circular, square, or diamond.

21. The material reducing machine of claim 14, including one of a horizontal grinder and a tub grinder.

22. A material reducing apparatus comprising:
a material reducing screen having an inner side and an outer side, the material reducing screen including:
a plurality of slot openings that extend through the material reducing screen from the inner side to the outer side;
a material tumbler bar located at the inner side of the material reducing screen, the material tumbler bar extending across the plurality of slot openings; and
openings formed by the material tumbler bar on the inner side of the material reducing screen above the plurality of slot openings.

23. The material reducing apparatus of claim 22, wherein the openings are smaller than the plurality of slot openings.

24. The material reducing apparatus of claim 22, wherein material is capable of being passed from the inner side of the material reducing screen to the outer side of the material reducing screen through the plurality of slot openings, the plurality of slot openings behind the material tumbler bar at the outer side of the material reducing screen being larger than the openings defined between the plurality of slot openings and the material tumbler bar at the inner side of the material reducing screen.
